(19) United States
(12) Patent Application Publication
(10) Pub. No.: US 2008/0276103 A1
(43) Pub. Date: Nov. 6, 2008

(54) Universal serial bus assembly structure

(75) Inventor: Jen-Jen Cheng, Jhonghe-City (TW)

Correspondence Address: Troxell Law Office Pllc, Suite 1404, 5205 Leesburg Pike, Falls Church, VA, 22041, US

(73) Assignee: Edac Power Electronics Co., Ltd.

(21) Appl. No.: 11/797,639

(22) Filed: May 4, 2007

(51) Int. Cl. G06F 1/00

(52) U.S. Cl. 713/300

(57) ABSTRACT

A USB (Universal Serial Bus) assembly structure is composed of a power supply device, a lead wire, an electromagnetic wave elimination device, a power adapter, and a plug, wherein a side of the lead wire is provided with a USB power supply device, such that when a computer is not turned on or is hibernated, power can be still supplied by the USB power supply device. In addition, when a computer is not provided with enough USB slots, it is still convenient to supply the USB power.

### BACKGROUND OF THE INVENTION

(a) Field of the Invention

The present invention relates to a USB (Universal Serial Bus) assembly structure, and more particularly to a USB assembly structure which is provided with a USB power supply device being installed at a power supply of a computer.

(b) Description of the Prior Art

Referring to FIG. 1, a conventional power supply device A is constituted by a plug A1, a power adapter A2, an electromagnetic wave elimination device A3, and a lead wire A4. As the power supply device A is not provided with a USB (Universal Serial Bus) power supply function, therefore, if it is required to supply power through the USB, a USB slot of a computer is still needed. Moreover, when the computer is turned off, in a hibernation state, or not provided with enough USB slots, the USB power supply function is not available.

Accordingly, how to eliminate the aforementioned problems is a technical issue to be solved by the present inventor.

### SUMMARY OF THE INVENTION

The primary object of present invention is to provide a USB (Universal Serial Bus) assembly structure which is provided with a USB power supply device being installed at a side of lead wire of a computer power supply device, such that when the computer is not turned on, is hibernated, or is not provided with enough USB slots, the USB power supply function is still available.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional power supply device.

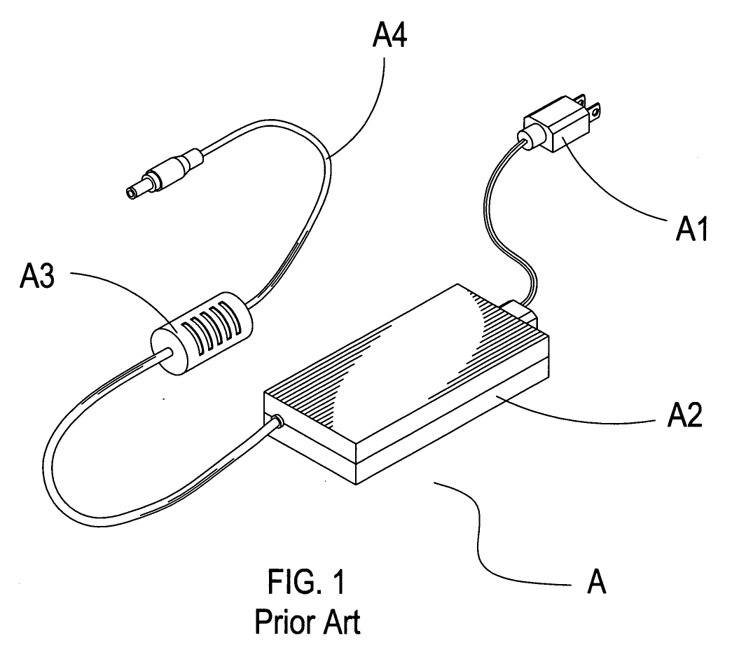

FIG. 2 shows a perspective view of the present invention.

FIG. 3 shows a first schematic view of an embodiment of the present invention.

FIG. 4 shows a second schematic view of an embodiment of the present invention.

FIG. 5 shows a third schematic view of an embodiment of the present invention.

FIG. 6 shows a fourth schematic view of an embodiment of the present invention.

FIG. 7 shows a fifth schematic view of an embodiment of the present invention.

FIG. 8 shows a first schematic view of a further embodiment of the present invention.

FIG. 9 shows a second schematic view of a further embodiment of the present invention.

FIG. 10 shows a third schematic view of a further embodiment of the present invention.

### DETAILED DESCRIPTION OF THE PREFERRED EMBODIMENTS

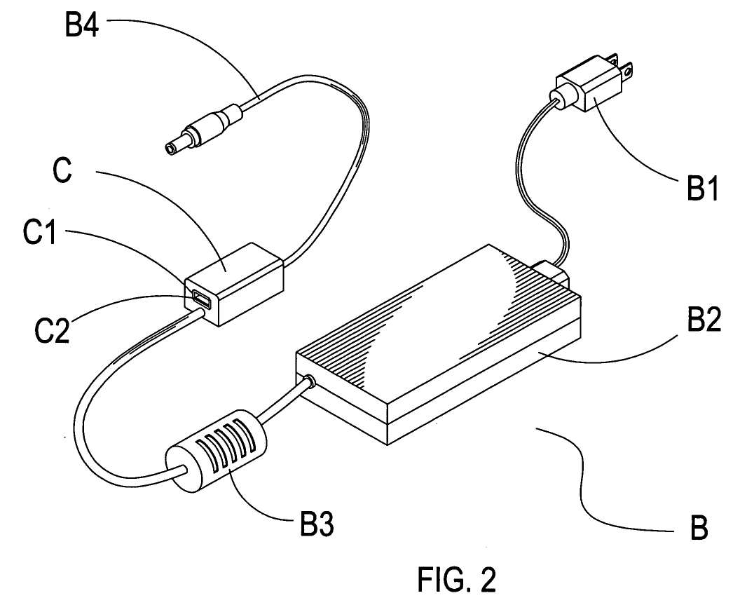

Referring to FIG. 2, the present invention is to provide a USB (Universal Serial Bus) assembly structure which includes a power supply device B, a plug B1, a power adapter B2, an electromagnetic wave elimination device B3, and a lead wire B4, wherein a side of the lead wire B4 is disposed with a USB power supply device C which is installed with a USB insertion hole C1 for inserting a USB plug. The USB insertion hole C1 is provided with a plurality of conduction terminals C2 for assembling with a 3C electronic product and for supplying power. Through the USB power supply device C at the lead wire B4, a user can use the USB to supply power at a same time when the power supply device B is conducted.

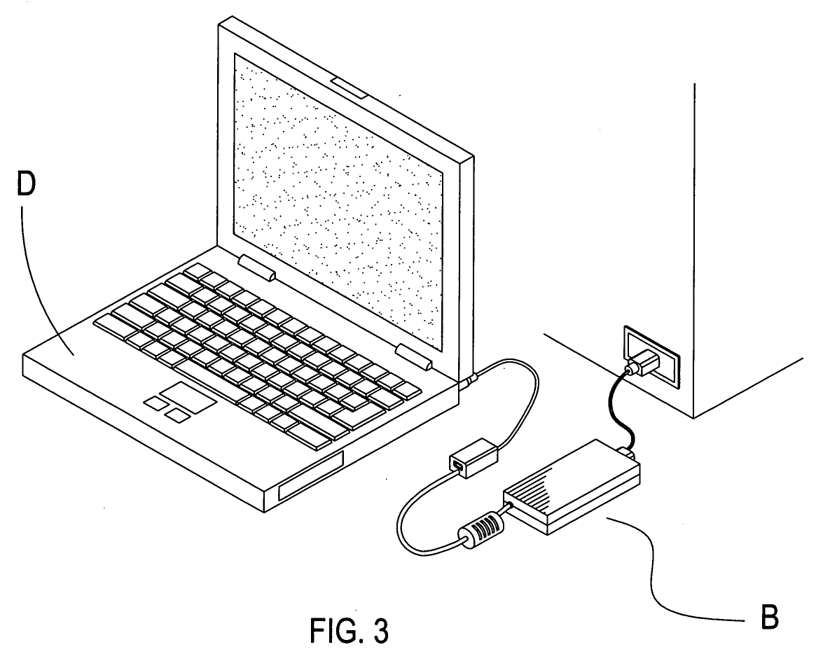

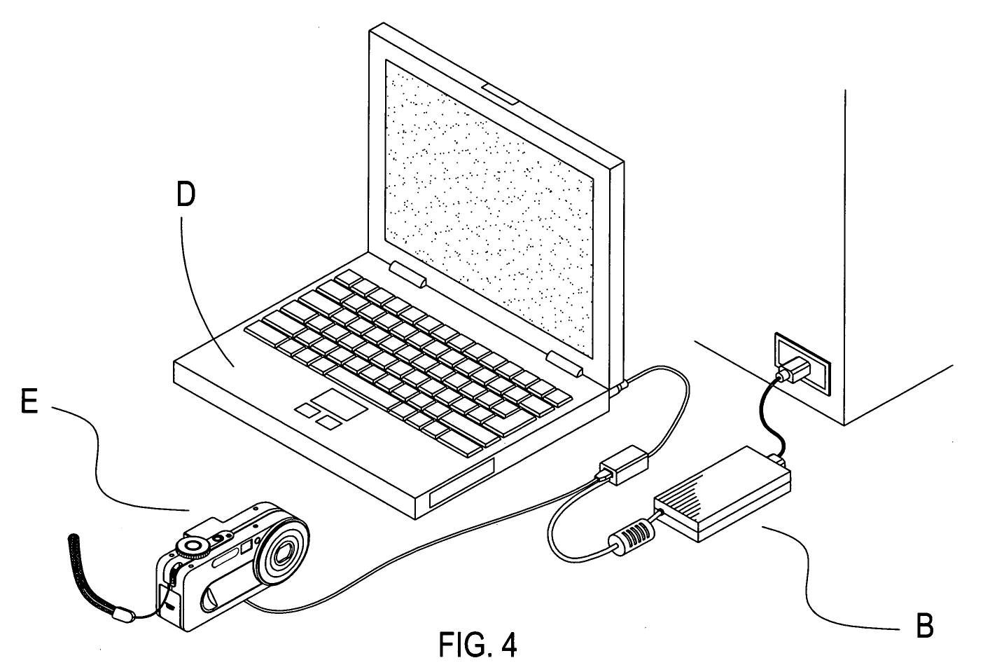

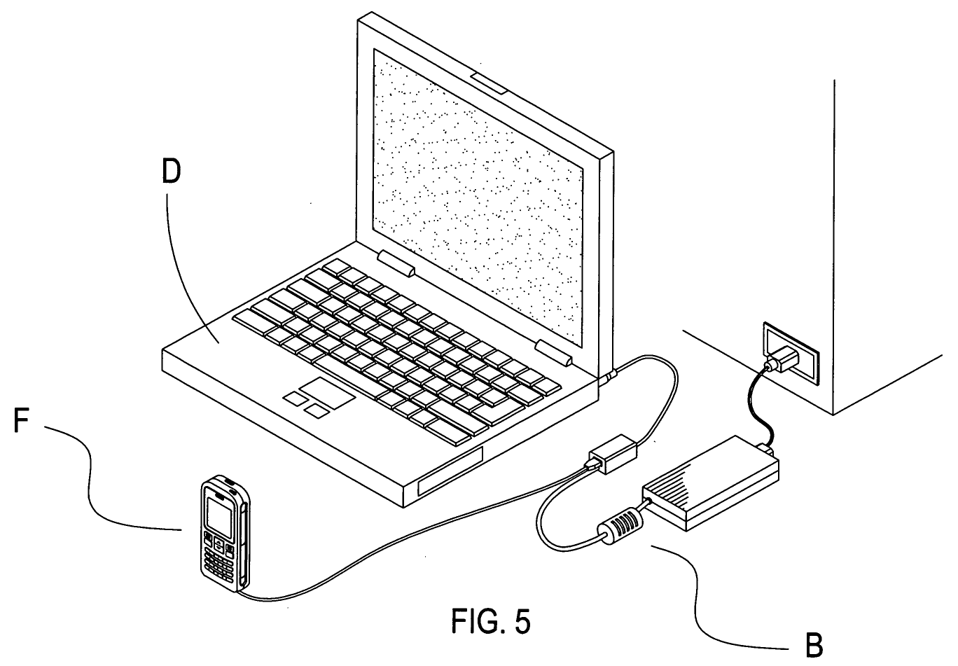

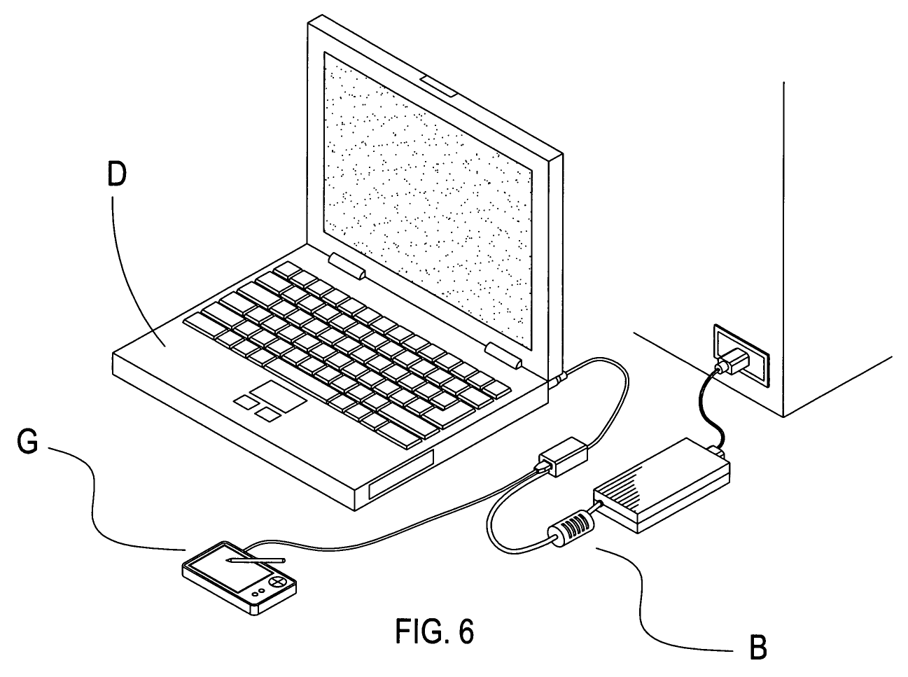

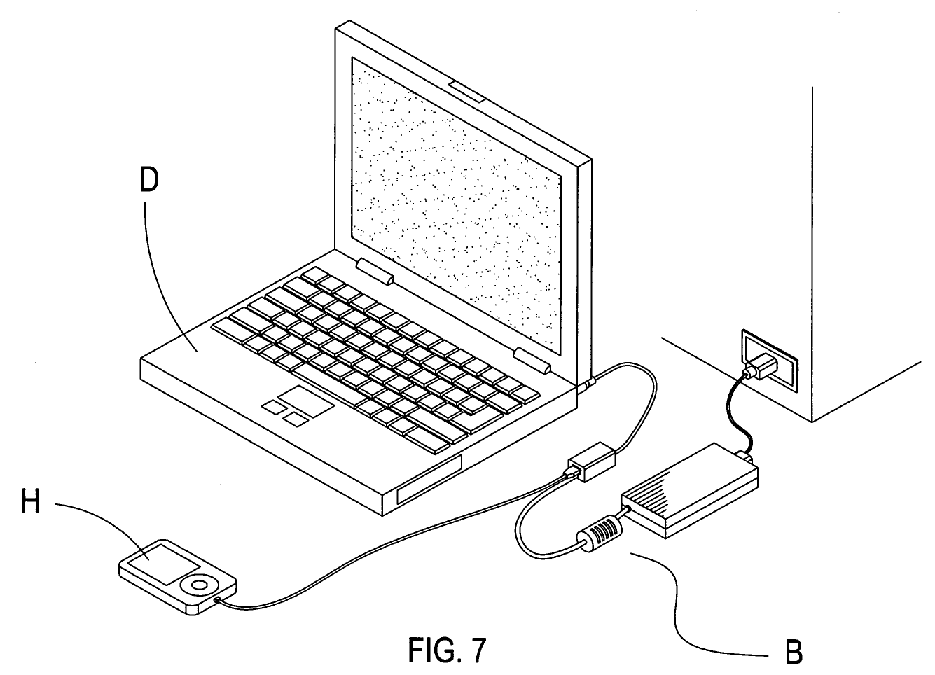

Referring to FIGS. 2 to 7, the USB power supply device C is located at one side of the lead wire B4. After the plug B1 is inserted into a power socket, power can pass through the power adapter B2 via the lead wire B4, and an electromagnetic wave which is generated when electriccurrent passes through the lead wire B4 can be eliminated by the electromagnetic wave elimination device B3. When the electric current passes through the USB power supply device C at the lead wire B4, as the USB insertion hole C1 of the USB power supply device C is provided with the conduction terminals C2, a 3C electronic product can be assembled and conducted, thereby achieving a function of supplying power.

Furthermore, after the plug B1 of power supply device B is inserted into the power socket, power can be provided to a computer D. In addition, the USB power supply device C at the lead wire B4 can also provide USB power to a camera E, a cellular phone F, a PDA (Personal Digital Assistant) G, or an iPod H.

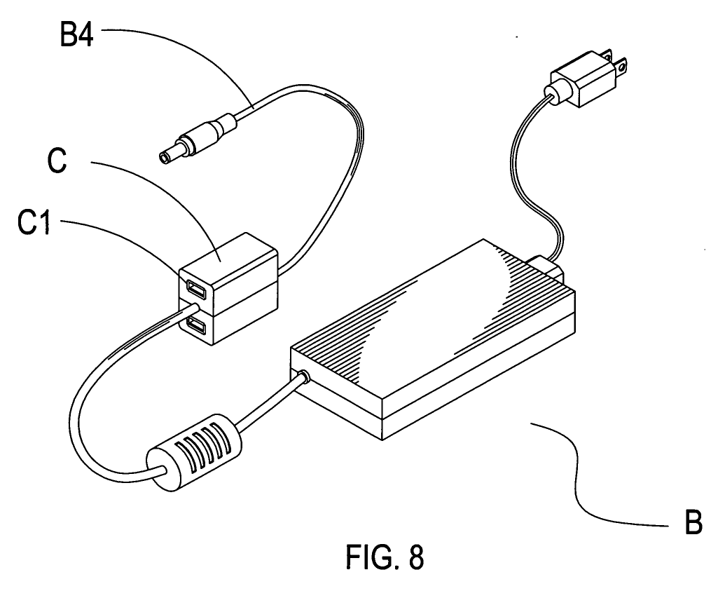

Referring to FIG. 8, the power supply device B can be further provided with a plurality of USB power supply devices C at the lead wire B4, with a plurality of USB insertion holes C1 for supplying power.

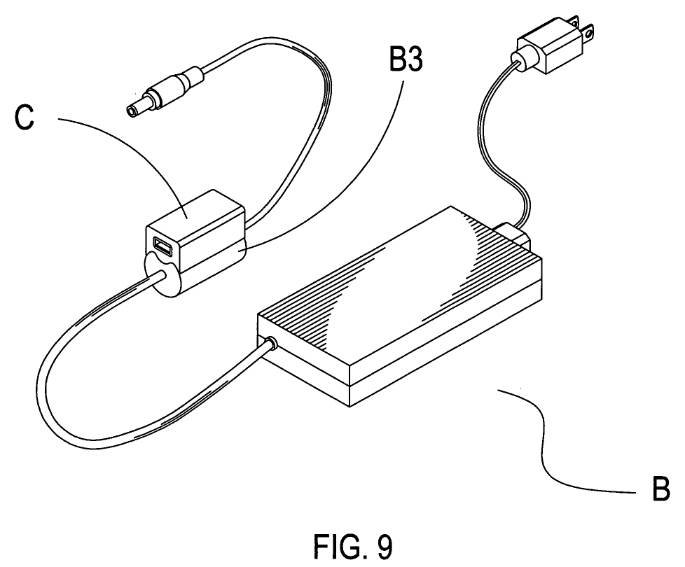

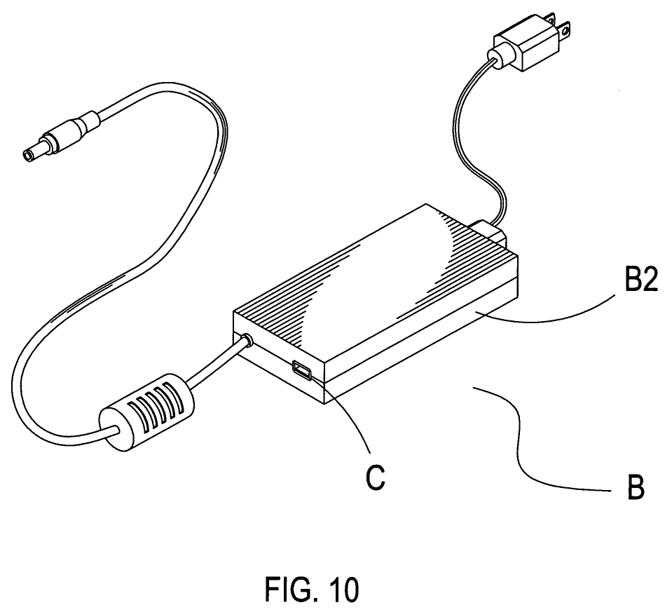

Referring to FIG. 9 and FIG. 10, the USB power supply device C of the power supply device B can be further configured at the electromagnetic wave elimination device B3, and can be also further configured at the power adapter B2 to proceed with supplying the USB power.

In order to further manifest advancement and practicability of the present invention, it is compared with a conventional device as below.

Shortcomings of a Conventional Device
1. The USB power should be supplied from a computer which can provide the USB power and cannot be directly provided by a power device.
2. When the computer is turned off, hibernated, or not provided with enough USB slots, the USB power supply function is not available.
3. According to item 2, it is in lack of convenience.

### ADVANTAGES OF THE PRESENT INVENTION

1. Power can be supplied directly from the USB power supply device which is installed by a power device.
2. Supplying the USB power can be carried out without turning on a computer.
3. According to item 1, it is provided with convenience.
4. According to item 2, it is provided with practicability.
5. It can save space to be used.
6. It is provided with advancement and practicability.
7. It can improve industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A USB (Universal Serial Bus) assembly structure comprising a power supply device, a lead wire, an electromagnetic wave elimination device, a power adapter, and a plug, wherein a side of the lead wire is provided with a USB power supply device to facilitate supplying power.

2. The USB assembly structure according to claim 1, wherein a plurality of USB power supply devices is further deployed on the lead wire.

3. The USB assembly structure according to claim 1, wherein the USB power supply device is further deployed on the power adapter.

4. The USB assembly structure according to claim 1, wherein the USB power supply device is further deployed on the electromagnetic wave elimination device.

5. The USB assembly structure according to claim 1, wherein the USB power supply device is further configured as a connector, including a USB interface slot, an SATA (Serial Advanced Technology Attachment) interface slot, or an HDMI (High-Definition Multimedia Interface) slot.
